(19) United States
(12) Patent Application Publication
(10) Pub. No.: US 2009/0207138 A1
(43) Pub. Date: Aug. 20, 2009

(54) SELECTING A LAYOUT

(75) Inventor: Ola Karl THORN, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/032,788

(22) Filed: Feb. 18, 2008

(51) Int. Cl. G06F 3/041

(52) U.S. Cl. 345/173

(57) ABSTRACT

A device may display content in an area on a surface of a touch screen, obtain a signal in response to a touch on the surface, determine a touch pattern associated with the touch, select a portrait layout or a landscape layout for displaying the content based on the touch pattern, and display the content in the area on the touch screen in the selected layout.

### BACKGROUND

An application executed by a hand-held mobile device (e.g., a cell phone) may display a graphical object (e.g., a photograph) in either a portrait layout or a landscape layout, depending on the shape or the size of the graphical object.

### SUMMARY

According to one aspect, a method may include displaying content in an area on a surface of a touch screen, obtaining a signal in response to a touch on the surface, determining a touch pattern associated with the touch, selecting a portrait layout or a landscape layout for displaying the content based on the touch pattern, and displaying the content in the area on the touch screen in the selected layout.

Additionally, obtaining a signal may include at least one of receiving information about a location of the touch on the surface of the touch screen, or receiving an image of the touch on the surface of the touch screen.

Additionally, determining a touch pattern may include at least one of comparing an image of the touch to a stored image, comparing characteristics that are associated with the touch to stored characteristics, or determining an angle associated with the touch relative to one side of the touch screen based on the signal.

Additionally, determining an angle may include determining the angle based on the image of the touch, or determining the angle based on a starting location of the touch and an end location of the touch on the surface of the touch screen.

Additionally, selecting a portrait layout or a landscape layout may include selecting a layout that best matches the angle associated with the touch.

Additionally, obtaining a signal may includes one of receiving a pointer event that encapsulates information about the touch, or receiving a message that includes information defining characteristics of the touch.

Additionally, displaying the content may include rotating the content of the area in accordance with the selected layout.

Additionally, the method may further include displaying a second area on the touch screen in a layout in accordance with output of a sensor that detects physical orientation of the touch screen.

Additionally, the method may further include updating the displayed content in the area in accordance with the selected layout when a user changes the content.

According to another aspect, a device may include a touch screen and a processor. The touch screen may be configured to receive an input touch from a user, and produce output based on the input touch. The processor may be configured to display a window on a surface of the touch screen, generate an event object based on the output from the touch screen, select a layout for the window in accordance with the event object, rotate content of the window based on the layout, and display the rotated content in the window in the selected layout.

Additionally, the device may include one of a portable phone, a laptop computer, a personal digital assistant, or a personal computer.

Additionally, the device may further include a sensor to produce a signal, based on physical orientation of the touch screen, for determining a layout of another window on the touch screen.

Additionally, the sensor may include a gyroscope or an accelerometer.

Additionally, the event object may include a pointer event associated with a cursor or tracking mechanism that tracks the touch on the surface of the touch screen.

Additionally, the event object may include information associated with at least one of a location of the input touch on the surface of the touch screen, or an image of the input touch.

According to yet another aspect, a computer-readable memory may include computer-executable instructions. The computer-executable instructions may include instructions for generating a message that encapsulates characteristics of a touch on a surface of a touch screen, instructions for determining an angle based on information included in the message, instructions for selecting a layout of an area on the surface of the touch screen based on the angle, instructions for rotating viewable content in the area in accordance with the selected layout, and instructions for displaying the viewable content in the area on the touch screen.

Additionally, the message may include at least one of an image of the touch on the surface of the touch screen, or a starting location and an ending location of the touch.

Additionally, the instructions for determining the angle may include determining an angle between a side of the touch screen and a line connecting the starting location and the end location.

Additionally, the instructions for rotating viewable content may include instructions for identifying an axis of the image and determining an angle between the axis of the image and a side of the touch screen.

According to a further aspect, a device may include means for displaying a graphical object, detecting a touch, and generating output in response to the touch, means for encapsulating the output in a message, means for receiving the message, means for determining a touch pattern based on the message, means for selecting one of a portrait layout or a landscape layout based on the touch pattern, and means for causing the means for displaying a graphical object to display the graphical object in the selected layout.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIGS. 1A and 1B illustrate a use of an exemplary device in which concepts described herein may be implemented;

FIGS. 2A and 2B are front and rear views of the exemplary device of FIGS. 1A and 1B;

FIG. 3 is a block diagram of the exemplary device of FIGS. 2A and 2B;

FIG. 4 is a functional block diagram of the exemplary device of FIGS. 2A and 2B;

FIG. 5 is a functional block diagram of an exemplary directional-touch enabled application of FIG. 4;

FIG. 6A illustrates touching an exemplary touch screen of the exemplary device of FIG. 1A at an angle;

FIG. 6B shows an image that may be detected by the touch screen in FIG. 6A;

FIG. 7 shows different angles that may be detected by the exemplary directional-touch enabled application of FIG. 4;

FIGS. 8A through 8D illustrate different types of touches that may be detected by the exemplary directional-touch enabled application of FIG. 4;

FIG. 9 is a flow diagram of an exemplary process for selecting a portrait or landscape layout;

FIG. 10A shows a screen layout of another exemplary directional-touch enabled application of FIG. 4; and

FIG. 10B shows the screen layout of FIG. 10A after the exemplary directional-touch enabled application responds to a touch.

### DETAILED DESCRIPTION

The following detailed description refers to the accompanying drawings. The same reference numbers in different drawings may identify the same or similar elements. The terms “tap,” “knock,” and “touch” are interchangeably used herein and they may refer to a contact an object (e.g., a stylus) or part of a human body (e.g., finger) makes against a portion of a device.

In implementations described herein, a device (e.g., a portable phone) may display visual content (e.g., text, a picture, a photograph, a drawing, etc.). When a user touches a display of the device, the device may detect the touch and modify a layout of the display in accordance with the touch.

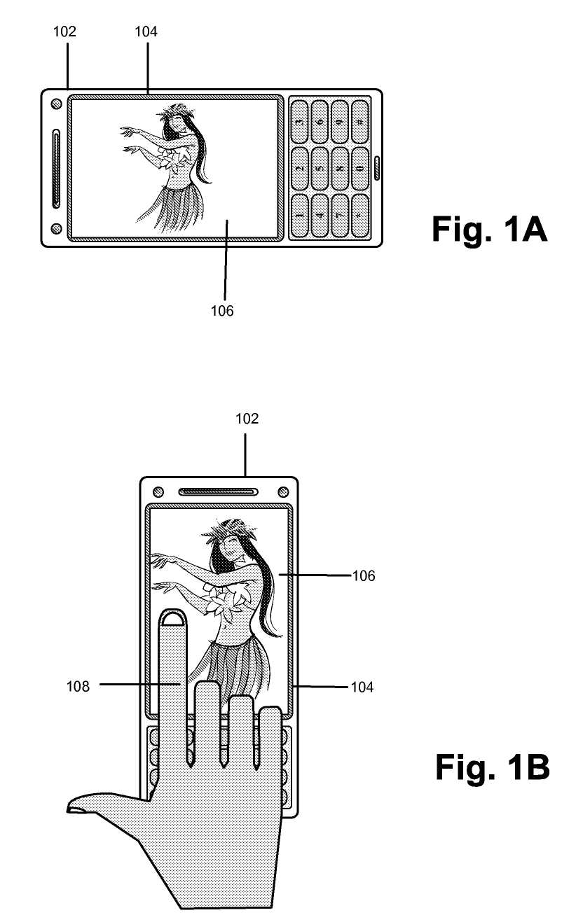

FIGS. 1A and 1B illustrate the above concept. More specifically, FIG. 1A shows an exemplary device 102. As shown, device 102 may include a display 104, which, in turn, may include a window 106 in a landscape layout. FIG. 1B shows same device 102 in a portrait layout. When a user touches display 104 of device 102 with a finger 108, device 102 may identify a pattern or direction associated with the touch. By rotating window 106 in accordance with the pattern/direction, device 102 may allow the user to view contents of window 106 in a layout that is convenient for the user.

As used herein, the term “landscape” or “landscape” layout may refer to a layout of a window (e.g., a graphical window in a screen) where the horizontal width of the window is greater than the vertical height of the window. The term “portrait” or “portrait layout,” may refer to a layout of a window where the horizontal width of the window is less than the vertical height of the window.

The term “window,” as used herein, may refer to a page, a frame, or any other rectangular surface on a display of a device. The window may include other windows, pages, or frames.

### Exemplary Network and Device

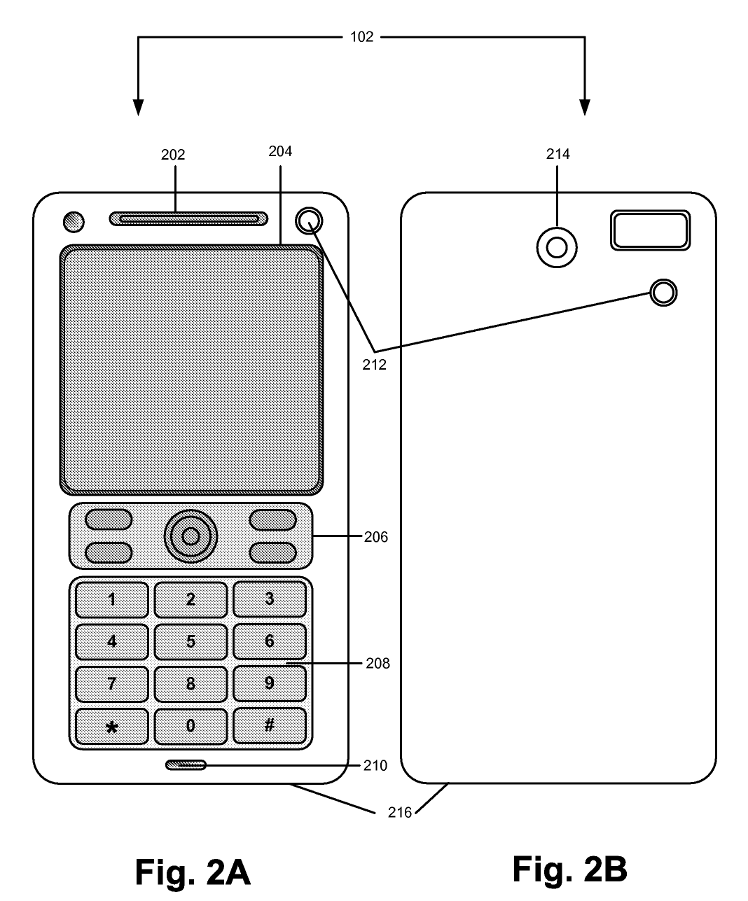

FIGS. 2A and 2B are front and rear views, respectively, of device 102. Device 102 may include any of the following devices that have the ability to or are adapted to communicate and interact with another device, such as a radiotelephone or a mobile telephone with ultra wide band or Bluetooth communication capability; a personal communications system (PC S) terminal that may combine a cellular radiotelephone with, data processing, facsimile, and/or data communications capabilities; an electronic notepad, a laptop, and/or a personal computer that communicate with wireless peripherals (e.g., a wireless keyboard, speakers, etc.); a personal digital assistant (PDA) that can include a telephone; a Global Positioning System device and/or another type of positioning device; a gaming device or console; a peripheral (e.g., wireless headphone); a digital camera; or another type of computational or communication device.

In this implementation, device 102 may take the form of a portable phone (e.g., a cell phone). As shown in FIGS. 2A and 2B, device 102 may include a speaker 202, a display 204, control buttons 206, a keypad 208, a microphone 210, sensors 212, a lens assembly 214, and housing 216. Speaker 202 may provide audible information to a user of device 102. Display 204 may provide visual information to the user, such as an image of a caller, video images, or pictures. Display 204 may include a touch screen, as described in detail below. Control buttons 206 may permit the user to interact with device 102 to cause device 102 to perform one or more operations, such as place or receive a telephone call. Keypad 208 may include a standard telephone keypad. Microphone 210 may receive audible information from the user. Sensors 212 may collect and provide, to device 102, information (e.g., acoustic, infrared, etc.) that is used to aid the user in capturing images. Lens assembly 214 may include a device for manipulating light rays from a given or a selected range, so that images in the range can be captured in a desired manner. Housing 216 may provide a casing for components of device 102 and may protect the components from outside elements.

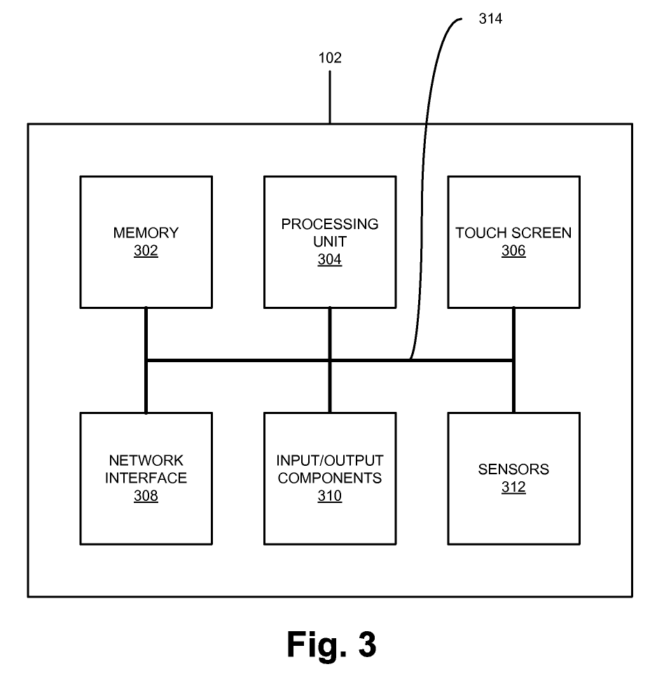

FIG. 3 is a block diagram of exemplary components of device 102. The term “component,” as used herein, may refer to hardware component, a software component, or a combination of the two. As shown, device 102 may include a memory 302, a processing unit 304, a touch screen 306, a network interface 308, input/output components 310, sensors 312, and communication path(s) 314. In other implementations, device 102 may include more, fewer, or different components.

Memory 302 may include static memory, such as read only memory (ROM), and/or dynamic memory, such as random access memory (RAM), or onboard cache, for storing data and machine-readable instructions. Memory 302 may also include storage devices, such as a floppy disk, CD ROM, CD read/write (R/W) disc, and/or flash memory, as well as other types of storage devices. Processing unit 304 may include a processor, a microprocessor, an Application Specific Integrated Circuit (ASIC), a Field Programmable Gate Array (FPGA), and/or other processing logic capable of controlling device 102.

Touch screen 306 may include a component that can display signals generated by device 102 as images on a screen and/or that can accept inputs in the form of taps or touches on the screen. For example, touch screen 306 may provide a graphical user interface through which a user can interact with device 102 to input a menu selection, move a mouse cursor, etc. In some implementations, touch screen 306 may be capable of providing a screen coordinates of a touch to other components of device 102. In other implementations, touch screen 306 may be capable of providing an image associated with the touch (e.g., a shape of a finger).

Examples of touch screen 306 may include a resistive, surface acoustic wave (SAW), capacitive, infrared, optical imaging, internal reflection, and/or another type of touch screen (e.g., a dispersive signal touch screen). A resistive touch screen may measure changes in surface resistance that may vary as a function of a location and an area of the touch. The change in resistance may be used to determine areas that are touched, and thus, an approximate image of the touch. A SAW touch screen may measure the changes in surface acoustic wave of the screen to locate the touch. The changes may depend on size and shape of an object (e.g., finger) touching the SAW touch screen. A capacitive touch screen may measure changes in capacitance when a finger touches the screen. The capacitive screen may be specifically constructed such that a touch along one axis of the screen modifies the screen capacitance differently than a touch along another axis. The changes in capacitance may be used to determine an area and a location of the touch.

An infrared touch screen may sense changes in a surface temperature of the screen to obtain an image and a location of a touch. An optical imaging touch screen may detect shadows that are cast by a touching finger against a backlight, to determine the image of the touch. An internal reflection touch screen may detect, via a camera, disruptions in internal light within a cavity of the screen when a finger presses against the surface of the touch screen, to obtain the size, shape and location of the touch.

Network interface 308 may include any transceiver-like mechanism that enables device 102 to communicate with other devices and/or systems. For example, network interface 308 may include mechanisms for communicating via a network, such as the Internet, a terrestrial wireless network (e.g., wireless local area network (WLAN)), a satellite-based network, a wireless personal area network (WPAN), etc. Additionally or alternatively, network interface 308 may include a modem, an Ethernet interface to a local area network (LAN), and/or an interface/connection for connecting device 102 to other devices (e.g., a Bluetooth interface). Further, network interface 308 may include one or more receivers, such as a Global Positioning System (GPS) or Beidou Navigation System (BNS) receiver for determining its own geographical location. Input/output components 310 may include a keypad (e.g., keypad 208 of FIG. 2), a button (e.g., control buttons 206), a mouse, a speaker (e.g., speaker 202), a microphone (e.g., microphone 210), a Digital Video Disk (DVD) writer, a DVD reader, Universal Serial Bus (USB) lines, and/or other types of devices for converting physical events or phenomena to and/or from digital signals that pertain to device 102.

Sensors 312 may include an accelerometer/gyroscope, a light sensor, a camera, an acoustic sensor, etc. The accelerometer/gyroscope may include hardware and/or software for determining acceleration/orientation of device 102. An example of accelerometer/gyroscope may include a micro electro mechanical system (MEMS) accelerometer/gyroscope that is coupled to the device housing for measuring device acceleration/orientation in one, two, or three axes. In one implementation, output of the accelerometer/gyroscope may be used to modify the screen layout of device 102. In some implementations, the camera may also be used to determine an image of the touch (e.g., an infrared touch screen, an optical imaging touch screen, etc.).

Communication path 314 may provide an interface through which components of device 102 can communicate with one another.

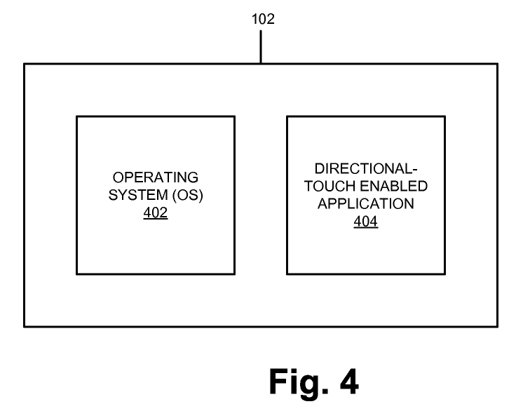

FIG. 4 is a functional block diagram of device 102. As shown, device 102 may include operating system (OS) 402 and directional-touch enabled application 404. Depending on the particular implementation, device 102 may include fewer, additional, or different types of functional blocks than those illustrated in FIG. 4, such as an email application, an instant messaging application, a browser, etc.

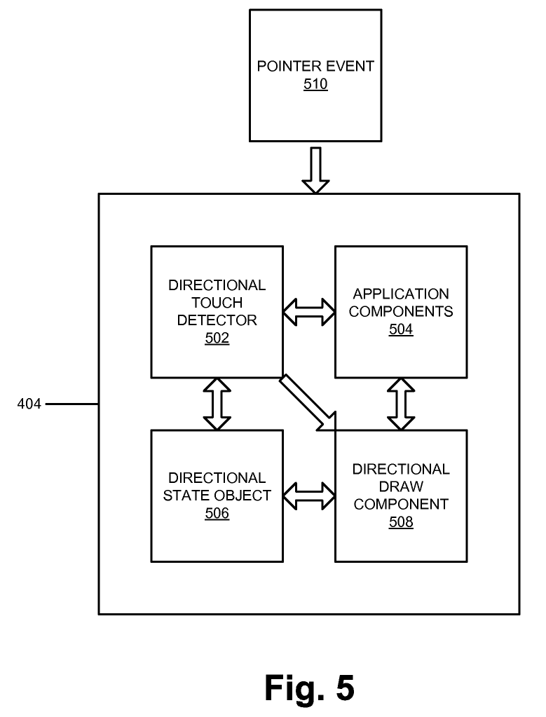

OS 402 may include hardware and/or software for performing various support functions for other components in FIG. 4 and FIG. 5 (e.g., network interface 308) and providing functionalities of device 102. For example, OS 402 may relay outputs of touch screen 306 and/or sensors 312 (e.g., a accelerometer/gyroscope) to directional-touch enabled application 404. In such instances, the outputs may include information about touches on touch screen 306 (e.g., a location of the touch, whether the touch is dragging across touch screen 306, an image of the touch, etc.) or the orientation of device 102. Examples of OS 402 may include Symbian OS, Palm OS, Windows Mobile OS, Blackberry OS, etc.

Directional-touch enabled application 404 may provide functionalities that are associated with an application on portable device 102 (e.g., an email client, an instant messaging client, a browser, etc.). In one implementation, directional-touch enabled application 404 may be implemented within a digital camera, to provide various functionalities that are associated with taking pictures (e.g., displaying an image on a viewfinder).

In addition, directional-touch enabled application 404 may accept user input to adjust viewable area of its user interface that is shown on touch screen 306. More specifically, depending on a touch, directional-touch enabled application 404 may display user interface windows in either a portrait layout or a landscape layout. For example, in the implementation where directional-touch enabled application 404 is implemented in a digital camera, directional-touch enabled application 404 may select a portrait layout or a landscape layout for taking a shot, depending on the touch. In a different implementation, directional-touch enabled application 404 may present user interface windows at an angle, as described below.

FIG. 5 is a functional block diagram of exemplary directional-touch enabled application 404. As shown, directional-touch enabled application 404 may include a directional touch detector 502, application components 504, a directional state object 506, and a directional draw component 508. Depending on the implementation, directional-touch enabled application 404 may include fewer, additional, or different components than those illustrated in FIG. 5.

As further shown in FIG. 5, directional-touch enabled application 404 may receive pointer event 510. Pointer event 510 may include an object or a message that is generated by OS 402 in response to signals or outputs from touch screen 306. Pointer event 510 may convey information that describes a touch on touch screen 306, such as coordinates or the location of the touch, the speed of taps that are produced by the touch, whether a cursor (e.g., a mouse cursor, a tracking mechanism, etc.) that tracks the touch is being dragged across touch screen 306, etc. In another implementation, pointer event 510 may convey an image that is associated with the shape of the touch.

Depending on the implementation, directional-touch enabled application 404 may receive other types of inputs or events from OS 402 (not shown in FIG. 5). For example, directional-touch enabled application 404 may receive input/events that are related to an incoming call, keypad 208 input, notifications that are generated when a component is plugged into device 102 (e.g., a flash memory stick), etc.

Directional touch detector 502 may receive pointer event 510 and, based on pointer event 510, may output a layout associated with a touch that occurred on the surface of touch screen 306. The layout may be determined based on information that may be extracted from pointer event 510, such as, for example, an image of the touch, a size and shape of the touch, orientation information that may be obtained from the touch, a location of the touch, etc.

The output of directional touch detector 502 may be provided to directional state object 506 and/or application components 504. In some implementations, if the output of directional touch detector 502 is different from the last output stored in directional state object 506, directional touch detector 502 may invoke directional draw component 508 to redraw windows that are displayed on touch screen 306 in different layouts.

Application components 504 may provide control related functionalities (e.g., control functions in model-view-controller architectural pattern) of directional-touch enabled application 404. For example, if directional-touch enabled application 404 includes an electronic album (e-album), application components 504 may store and/or retrieve digital photographs. Application components 504 may perform such functions in response to different events or inputs.

Directional state object 506 may receive information related to the layout associated with a touch from directional touch detector 502 and store the information. For example, if directional touch detector 502 outputs “LANDSCAPE,” indicating that a touch on touch screen 306 conveys a direction/orientation that is parallel to one side of a touch screen, directional state object 506 may store “LANDSCAPE.”

Directional draw component 508 may determine a particular layout of a viewable area (e.g., a window) on touch screen 306 based on the direction, modify the currently displayed information based on directional state object 506, and cause touch screen 306 to display the modified information in the viewable area. For example, if directional state object 506 includes “LANDSCAPE,” and a current layout of a window on touch screen 306 is the portrait layout, directional draw component 508 may modify the information currently displayed on touch screen 306 to reflect the landscape layout, and cause the modified information to be shown in the viewable area of touch screen 306.

In some implementations, directional-touch enabled application 404 may re-orient contents of windows in touch screen 306 in accordance with a specific touch pattern or information related to the touch pattern provided by pointer event 502. Depending on the implementation, the information may include touch screen layout other than those parallel or perpendicular to one of the sides of touch screen 306 (e.g., a landscape or portrait layout). In another implementation, directional-touch enabled application 404 may modify a change a layout of a viewable area (e.g., window) from a portrait layout to landscape layout without rotating the viewable area.

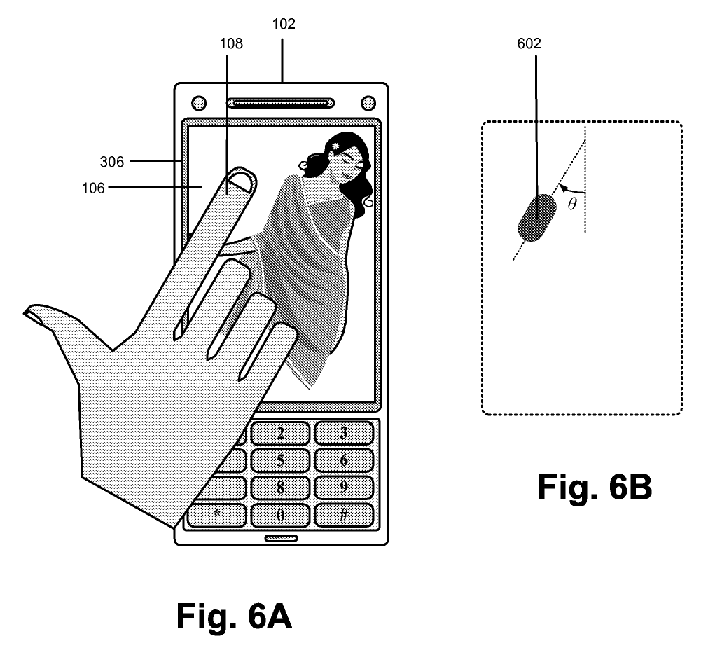

FIG. 6A illustrates touching touch screen 306 of device 102 in a direction that is not parallel or perpendicular to a side of touch screen 306. As shown, finger 108 may contact touch screen 306 at an angle, with respect to the sides of touch screen 306, and contents of window 106 may be displayed in accordance with the angle. That is, the image may be rotated by an angle corresponding to the touch angle.

FIG. 6B shows an image that may be detected by touch screen 306 in FIG. 6A when finger 108 touches touch screen 306. As shown, when a finger 108 touches touch screen 306, touch screen 306 may detect an image 602 that results from contact between finger 108 and touch screen 306. Image 602 may be outputted by touch screen 306, packaged, by OS 402, as part of pointer event 510, and conveyed to directional-touch enabled application 404. It should be understood that image 602 is illustrated in FIG. 6B for explanatory purposes and may be not be displayed by touch screen 306. Subsequently, directional touch detector 502 in directional-touch enabled application 404 may identify a lengthwise axis of image 602, and compare the direction of the axis to a direction of one of the sides (e.g., a vertical side) to determine angle θ from image 602.

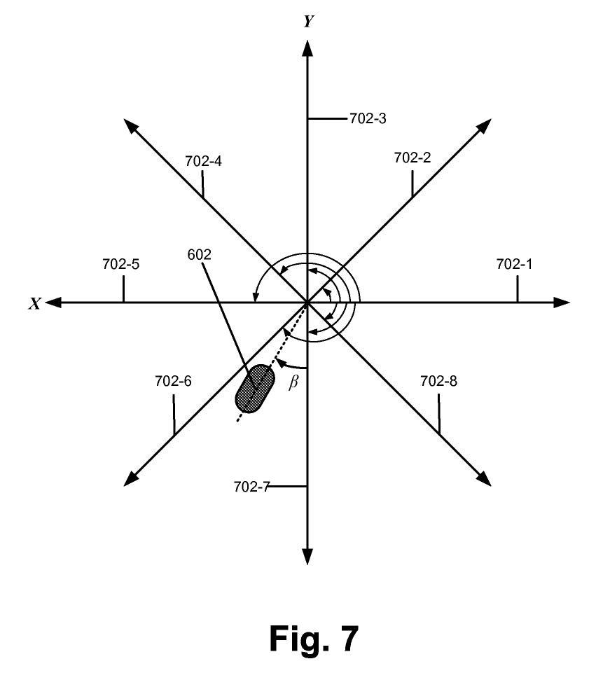

In some implementations, directional touch detector 502 may permit angle θ to assume one of predetermined set of values. FIG. 7 illustrates angles 702-1 though 702-8 (herein collectively referred to as angles 702 and individually as 702-x) that may be detected by directional touch detector 502. As shown, each of permitted angles 702 may be a multiple of 45 degrees. If image 602 is determined as having angle β, angle 702-x that is closest to angle β may be determined as angle θ (e.g., angle 702-6).

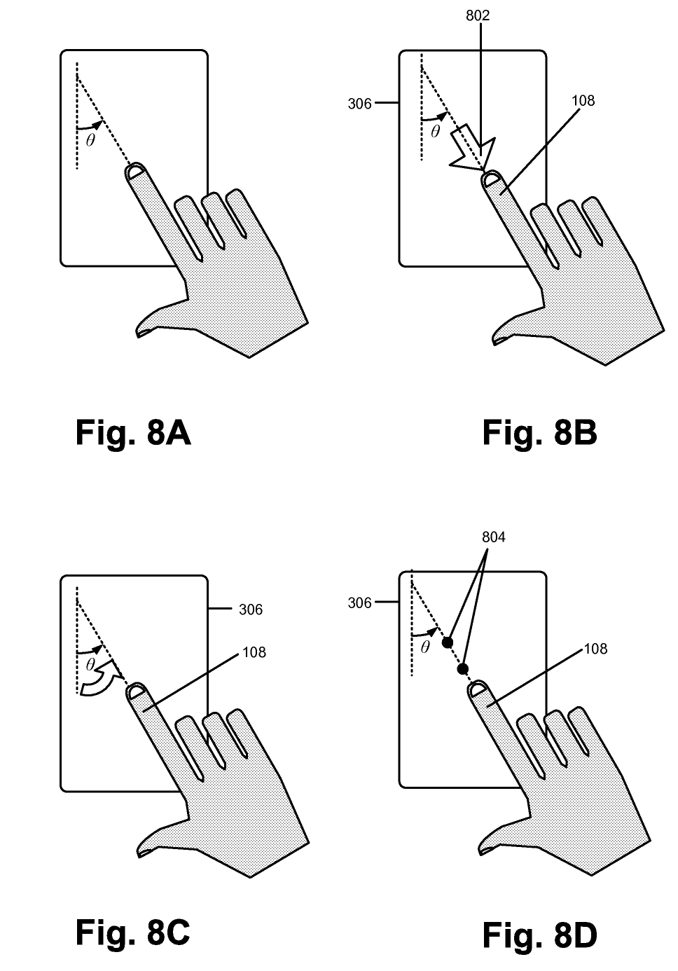

FIGS. 8A through 8D illustrate different types of touches that may be detected by various components of device 102. FIG. 8A shows a stationary touch. In one implementation, an image detected from the stationary touch may be compared against a stored image that represents a layout. Thus, for example, if an image of touch that is parallel to a longer side of touch screen 306 may be matched to a stored image of a touch that is associated with portrait layout. In another situation, an image of touch (e.g., an image associated with the user's finger) that is parallel to the shorter side may be matched to an image of a touch that is associated with a landscape layout. In theses cases, the layout may be switched. In another implementation, as discussed above, angle θ for the stationary touch may be determined from the image of the touch.

FIG. 8B shows a dragging touch. As shown, finger 108 may be dragged across touch screen 306 from a starting position to an end position in a direction indicated by arrow 802. In one implementation, images that are generated by the dragging touch or characteristics that are associated with the dragging touch may be compared to pre-stored images/characteristics (.e.g., thickness, length, etc.). Based on a result of the comparison, directional-touch enabled application 404 may determine whether to display windows on touch screen 306 in a portrait layout or a landscape layout.

In a different implementation, pointer events 510 (generated at the start and at the end of the movement of finger 108) may provide the locations of the starting position and the end position of finger 108. In such an implementation, angle θ may be determined by comparing the direction of one of the sides of touch screen 306 to the direction of a line connecting the starting position and the end position of the touch on the surface of touch screen 306.

FIG. 8C shows a sweeping touch. As shown, finger 108 may sweep across touch screen 306 to traverse angle θ. The starting position/orientation and the end position/orientation of the touch, provided by pointer event 510, may be used to compute angle θ.

In some implementations, in place of a sweeping touch, finger 108 may rotate about a point of contact. In such a case, directional-touch enabled application 404 may cause an image or the window that is being touched to “stick” to the finger, and rotate with the finger. A similar effect may be achieved if touch screen 306 and the device is rotated while a finger is held stationary and in contact with the surface of touch screen 306.

FIG. 8D shows tapping touches. In some implementations, the number of taps on the same or different spots 804 of touch screen 306 within a particular amount of time (e.g., a second) may indicate a specific layout. Thus, for example, three taps may indicate a landscape layout, and two taps may indicate a portrait layout. In a different implementation, angle θ may be determined by comparing a direction of a line connecting spots 804 and the direction of one of the sides of touch screen 306.

While FIGS. 8A-8D illustrates some of touch patterns that may be detected for modifying the layout of windows on touch screen 306, in different implementations, device 102 may detect other types of touches not illustrated in FIGS. 8A-8D. For example, device 102 may detect a squiggly pattern, a circle, etc., each of which may indicate a layout of windows on touch screen 306.

In another implementation, if a window includes a three-dimensional figure or an object, specific touch patterns may be used to determine yaw, pitch, and roll of the figure (e.g., orientation in three dimensions) and to rotate the figure in accordance with the touch patterns. For example, if a finger touches the screen in a clockwise direction, the figure's roll may be modified.

### Exemplary Process for Selecting a Layout

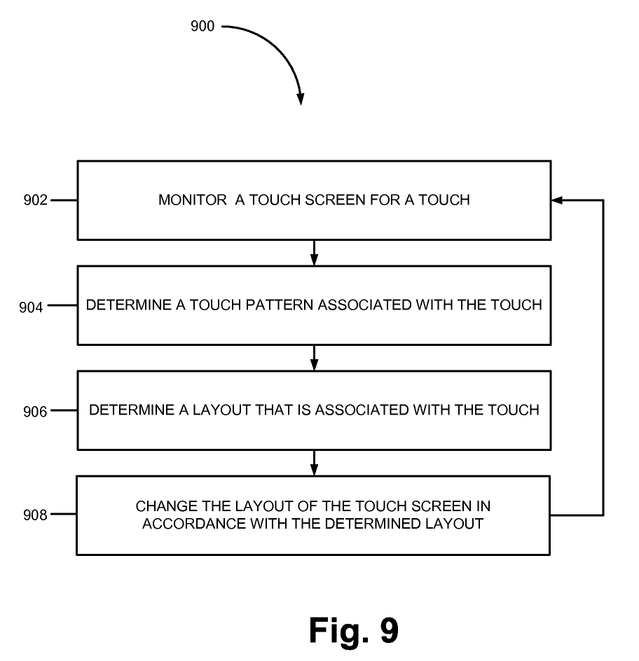

FIG. 9 shows an exemplary process 900 for selecting a layout. Assume that directional-touch enabled application 404 is operating in a mode where user touches on windows or images that are displayed on touch screen 306 may be interpreted as signals to change the layout of the windows. Process 900 may begin at block 902, where device 102 may monitor touch screen 306 of device 102 (block 902). In one implementation, OS 402 may monitor touch screen 306.

At block 904, device 102 may detect different types of touch patterns. As described above with respect to FIGS. 8A-8D, the different types of touch patterns may include a stationary touch, dragging touch, tapping touch, sweeping touch, etc. In some implementations, when a user touches touch screen 306, touch screen 306 may generate output indicating that the user has touched touch screen 306 and convey characteristics that are associated with one or more touches (e.g., the orientation of the touch, the location of the touch, a speed of tapping touch, an image of the touch, etc.) to other components of device 102 (e.g., OS 402, directional-touch enabled application 404, etc.).

Depending on the implementation, based on the detected touch pattern/characteristics, OS 402 may create pointer event 510 that encapsulates the touch pattern/characteristics. For example, in some implementations, device 102 may generate two pointer events that provide the starting location and the end location of the touch on touch screen 306, or alternatively, multiple pointer events representing multiple touches or taps on touch screen 306.

Device 102 may determine a layout associated with the touch (block 906). As described with reference to FIGS. 8A and 8D, directional-touch enabled application 404 may determine the layout based on the touch pattern/characteristics. For example, the layout may be determined by comparing an image of a touch against a stored image that is associated with a specific layout. In a different implementation, the layout may be determined by comparing characteristics (e.g., number of taps) of touches against stored characteristics.

In some implementations, as described above with reference to FIG. 8A-8D, depending on the implementation, directional-touch enabled application 404 may determine an angle by which windows in touch screen 306 may be rotated. For example, directional-touch enabled application 404 may determine the angle based on a stationary touch, a dragging touch, a sweeping touch, tapping touches, etc.

In such an implementation, directional-touch enabled application 404 may match the angle to a value that corresponds to one of a portrait or landscape layout (e.g., 90 degrees or 0 degrees). Thus, for example, if the angle is 60 degrees, directional-touch enabled application 404 may match the angle to 90 degrees, relative to a longer side of touch screen 306. In such a case, directional-touch enabled application 404 may determine that the touch specifies a landscape layout.

In other implementations, directional-touch enabled application 404 may match the angle to a value that corresponds to one of many possible layouts, as described with reference to FIG. 7. Each of the predetermined angles may correspond to an angle by which viewable content in a window of touch screen 306 may be rotated and presented in touch screen 306.

Directional-touch enabled application 404 may change the layout of windows in touch screen 306 in accordance with the determined layout (block 908). In one implementation, directional-touch enabled application 404 may employ directional draw component 508. Directional draw component 508 may change the layout of a window by shifting each pixel of an image(s) displayed in the window to a new location on touch screen 306. The new location may be obtained by, in effect, multiplying the original coordinates of the pixel by a rotational matrix associated with an angle that is determined based on the touch(es). For example, assume that a coordinate of a pixel is P=[1 0]. A rotational matrix R of the matching angle of 90 degrees clockwise may be given by the following expression,

$$R = [ \begin{matrix}0 & - 1 \\ 1 & 0\end{matrix} ] . \qquad ( 1 )$$

A new coordinate may be obtained by

$${P}_{ROTATED} = P \cdot R = [ \begin{matrix}1 & 0\end{matrix} ] [ \begin{matrix}0 & - 1 \\ 1 & 0\end{matrix} ] = [ \begin{matrix}0 & - 1\end{matrix} ] . \qquad ( 2 )$$

In some implementations, to change the portrait layout to the landscape layout, instead of using a rotational matrix, directional draw component 508 may derive P_{ROTATED} for each pixel P by exchanging the value of an x-coordinate of P with a y-coordinate of P.

At block 908, process may return to block 902, to continue to monitor touch screen 306.

### EXAMPLE

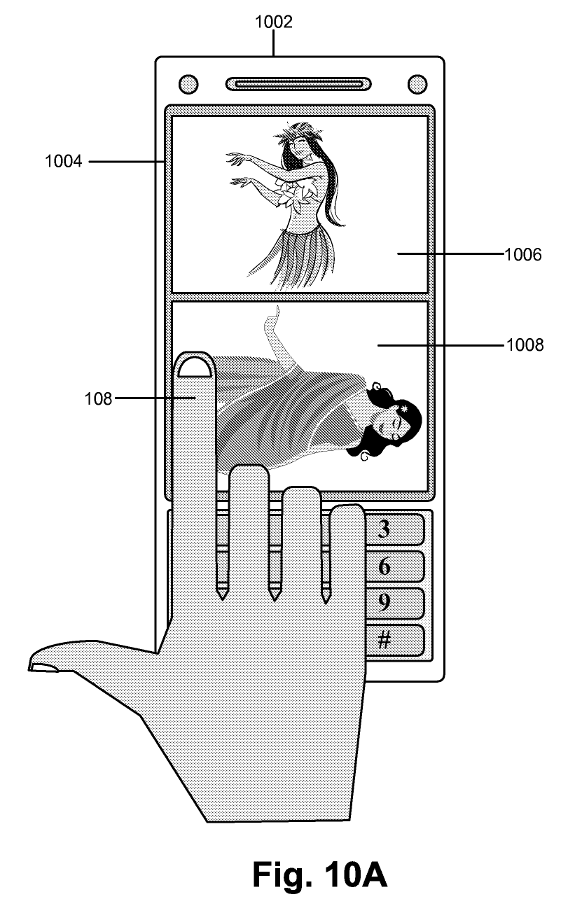

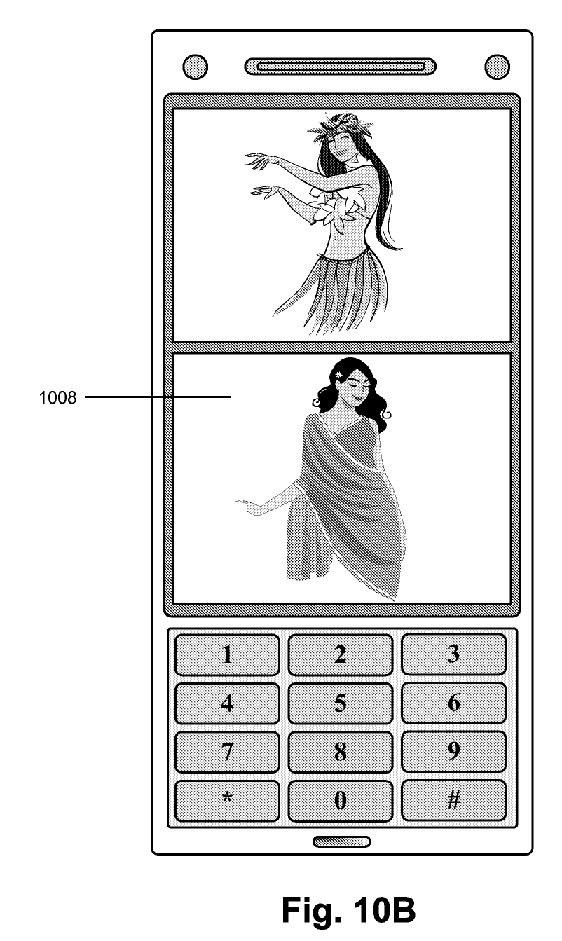

FIG. 10A and 10B illustrate a process involved in selecting a layout. The example is consistent with exemplary process 900 described above with reference to FIG. 9.

In FIG. 10A, assume Elena is using directional-touch enabled application 404 that is implemented as an e-album on device 1002. In addition, assume that the e-album allows each of windows 1006 and 1008 on touch screen 1004 to be displayed in a portrait layout or a landscape layout.

Elena touches window 1008. Consequently, device 102 generates a pointer event associated with the touch. The pointer event encapsulates the position of the touch and an image that finger 108 leaves on touch screen 1004.

Device 1002 compares the image encapsulated by the pointer event to a stored image that corresponds to a landscape layout and finds a match. Device 1002 determines the touch as being indicative of a landscape layout. Furthermore, based on the position information in the pointer event, device 1002 selects window 1008 to modify its layout, and rotates window 1008 counterclockwise 90 degrees.

FIG. 10B shows the result of placing window 1008 in a landscape layout. Elena is able to easily compare her own picture to other pictures in the e-album.

In some implementations, directional-touch enabled application 404 may allow layouts of different windows to be changed by different mechanisms. For example, in one implementation, in FIG. 10A, the layout of window 1006 may be changed based on the orientation of device 1002 relative to the direction of the Earth's gravity, and the layout of window 1008 may changed based on a touch. In a different implementation, device 1004 or device 102 may be provided with multiple screens. Directional-touch enabled application 404 may be implemented to control and/or modify layouts of different windows on different screens.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, in place of pointer event 510, internal components (e.g., OS 402, directional touch detector 502, etc.) may exchange messages to convey information about a touch. Such messages may carry information that is included in pointer event 5 10. In another example, in place of matching an image resulting from a touch to a stored image to determine a layout, device 102 may accept user touches on one or more pre-selected areas of touch screen 306 that may be extra sensitive to finger shape detection. For example, if a user touches a small region on a left hand side of touch screen 306, device 102 may show a landscape layout.

In yet another example, touch sensitive surfaces (e.g., a capacitive or a resistive buttons, panels, etc.) may be provided on the body of device 102 (e.g., digital camera). In such a case, the direction of the finger (e.g., portrait/landscape) on the touch sensitive surfaces may determine the direction of how an image is presented at a display screen or stored in memory, as the user's finger may be placed on the touch sensitive surfaces differently when the user is taking the picture in a portrait layout or a landscape layout. The touch sensitive surfaces may be placed on different areas of the device, e.g., backside, top, etc.

In the above, while a series of blocks has been described with regard to an exemplary process illustrated in FIG. 9, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. A method comprising:
displaying content in an area on a surface of a touch screen;
obtaining a signal in response to a touch on the surface;
determining a touch pattern associated with the touch;
selecting a portrait layout or a landscape layout for displaying the content based on the touch pattern; and
displaying the content in the area on the touch screen in the selected layout.

2. The method of claim 1, where obtaining a signal includes at least one of:
receiving information about a location of the touch on the surface of the touch screen; or
receiving an image of the touch on the surface of the touch screen.

3. The method of claim 1, where determining a touch pattern includes at least one of:
comparing an image of the touch to a stored image;
comparing characteristics that are associated with the touch to stored characteristics; or
determining an angle associated with the touch relative to one side of the touch screen based on the signal.

4. The method of claim 3, where determining an angle includes:
determining the angle based on the image of the touch; or
determining the angle based on a starting location of the touch and an end location of the touch on the surface of the touch screen.

5. The method of claim 3, where selecting a portrait layout or a landscape layout includes:
selecting a layout that best matches the angle associated with the touch.

6. The method of claim 1, where obtaining a signal includes one of:
receiving a pointer event that encapsulates information about the touch; or
receiving a message that includes information defining characteristics of the touch.

7. The method of claim 1, where displaying the content includes:
rotating the content of the area in accordance with the selected layout.

8. The method of claim 1, further comprising:
displaying a second area on the touch screen in a layout in accordance with output of a sensor that detects physical orientation of the touch screen.

9. The method of claim 1, further comprising:
updating the displayed content in the area in accordance with the selected layout when a user changes the content.

10. A device comprising:
a touch screen configured to:
receive an input touch from a user, and
produce output based on the input touch; and
a processor configured to:
display a window on a surface of the touch screen,
generate an event object based on the output from the touch screen,
select a layout for the window in accordance with the event object,
rotate content of the window based on the layout, and
display the rotated content in the window in the selected layout.

11. The device of claim 10, where the device comprises one of:
a portable phone;
a laptop computer;
a personal digital assistant;
a personal computer;
a gaming console;
a digital camera; or
a global positioning system device.

12. The device of claim 10, further comprising:
a sensor to produce a signal, based on physical orientation of the touch screen, for determining a layout of another window on the touch screen.

13. The device of claim 12, where the sensor includes a gyroscope or an accelerometer.

14. The device of claim 10, where the event object includes:
a pointer event associated with a cursor or tracking mechanism that tracks the touch on the surface of the touch screen.

15. The device of claim 10, where the event object includes information associated with at least one of:
a location of the input touch on the surface of the touch screen; or
an image of the input touch.

16. A computer-readable memory comprising computer-executable instructions, the computer-executable instructions including:
instructions for generating a message that encapsulates characteristics of a touch on a surface of a touch screen;
instructions for determining an angle based on information included in the message;
instructions for selecting a layout of an area on the surface of the touch screen based on the angle;
instructions for rotating viewable content in the area in accordance with the selected layout; and
instructions for displaying the viewable content in the area on the touch screen.

17. The computer readable memory of claim 16, where the message includes at least one of:
an image of the touch on the surface of the touch screen; or
a starting location and an ending location of the touch.

18. The computer-readable memory of claim 17, where the instructions for determining the angle include:
determining an angle between a side of the touch screen and a line connecting the starting location and the end location.

19. The computer readable memory of claim 17, where the instructions for rotating viewable content include:
instructions for identifying an axis of the image and determining an angle between the axis of the image and a side of the touch screen.

20. A device comprising:
means for displaying a graphical object, detecting a touch, and generating output in response to the touch;
means for encapsulating the output in a message;
means for receiving the message;
means for determining a touch pattern based on the message;
means for selecting one of a portrait layout or a landscape layout based on the touch pattern; and
means for causing the means for displaying a graphical object to display the graphical object in the selected layout.
